(19) United States
(12) Patent Application Publication
(10) Pub. No.: US 2024/0422666 A1
(43) Pub. Date: Dec. 19, 2024

(54) ALLOCATING CELL SITE COMPONENT CAPACITY TO CONSERVE POWER

(71) Applicant: DISH Wireless L.L.C., Englewood, CO (US)

(72) Inventor: Karupaiah Rajendran, Sachse, TX (US)

(21) Appl. No.: 18/623,876

(22) Filed: Apr. 1, 2024

Related U.S. Application Data
(60) Provisional application No. 63/472,890, filed on Jun. 14, 2023.

(51) Int. Cl. H04W 52/02

(52) U.S. Cl. CPC H04W 52/0206

(57) ABSTRACT

Techniques for allocating cell site component capacity to conserve power are disclosed. Antenna ports of a radio unit are identified and a capacity for each antenna port is obtained. A throughput of a first antenna is obtained. A configuration for the first antenna is determined based on the throughput and the antenna port capacities. One or more antenna ports are selected, based on the capacities and the configuration for the first antenna, to allocate to the first antenna. The one or more antenna ports of the radio unit are then allocated to the first antenna. Antenna ports of the radio unit that are not allocated to the first antenna may be entered into a reduced-power state or allocated to a second antenna of the cell site.

### CROSS-REFERENCE TO RELATED APPLICATION(S)

This application claims the benefit and priority to U.S. Application No. 63/472,890, filed Jun. 14, 2023, the entirety of which is hereby incorporated by reference.

### BACKGROUND

Demand for mobile bandwidth continues to grow as customers access new services and applications. To remain competitive, telecommunications companies are cost-effectively expanding their networks while also improving user experience.

In some implementations of cellular networks, for example 5G cellular networks, the entirety of an antenna's structure (e.g., all network ports), along with certain reference signals and other components within resource blocks are used at all times to enhance transmission and reception capabilities.

### BRIEF SUMMARY

A typical cell site includes a distributed unit (DU), a cell site router (CSR), one or more radio units (RUs), and one or more directional antennas having coverage areas called sectors. Typically, the distributed unit is in communication with the cell site router. The cell site router is in turn in communication with one or more radio units, for example, 6 radio units. In conventional cell sites, each radio unit services one antenna that services one sector. For example, the 6 radio units may be connected to 3 antennas via antenna power amplifiers. Typically, 5G antenna systems are configured to use 4 transmitting ports and 4 receiving ports (4T4R). Thus, two radio units with 4 antenna ports each may serve one 4T4R antenna. But the power requirements of a 4T4R antenna system are relatively high, even when the system is idle or experiencing little traffic or throughput. Because typical 5G antenna systems use 4T4R antenna configurations regardless of traffic, large amounts of power may be wasted maintaining 4T4R antenna configurations. To reduce power consumption, radio unit or distributed unit capacity may be split between multiple antennas of a cell site in a split-sector configuration, allowing, for example, one radio unit to serve two or more sectors using.

In some embodiments, a method for allocating capacity of a radio unit between a plurality of antennas of a cell site is performed by identifying antenna ports of the radio unit. Then, a capacity for each of the plurality of antenna ports is obtained. A throughput of a first antenna in the plurality of antennas is assessed. Then, a configuration for the first antenna is determined based on the throughput and the capacities. Based on the capacities of the antenna ports and the configuration for the first antenna, one or more antenna ports are dynamically selected to allocate to the first antenna. The one or more antenna ports of the radio unit are then allocated to the first antenna.

In some embodiments, an antenna port of the radio unit that is not allocated to the first antenna is allocated to a second antenna. In some embodiments, an antenna port of the radio unit that is not allocated to the first antenna is entered into a reduced-power state. In some embodiments, allocating the one or more antenna ports of the radio unit to the first antenna includes reducing a number of antenna ports of the radio unit that are allocated to the first antenna. In some embodiments, the method further includes connecting the one or more antenna ports of the radio unit to one or more antenna amplifiers that are connected to the first antenna. In some embodiments, the method further includes switching the one or more antenna ports of the radio unit to communicate with the first antenna. In some embodiments, the method further includes selecting an antenna port that is allocated to a second antenna and turning off the selected antenna port. In some embodiments, the selected radio unit is turned on in response to detecting that a throughput of the first antenna exceeds a throughput threshold.

### BRIEF DESCRIPTION OF THE DRAWINGS

FIG. 1 illustrates a high level block diagram showing a 5G cellular network using vDUs and a vCU.

FIG. 2 is a diagram of radio frames within a cell according to some embodiments.

FIG. 3 is a diagram of several types of antennas within a cellular network according to some embodiments.

FIG. 4A is a diagram of an arrangement of several types of antennas within a cellular network connected to processing hardware according to some embodiments.

FIG. 4B illustrates a logical flow diagram showing one embodiment of a process for dynamically allocating capacity of a radio unit to an antenna.

FIG. 5 illustrates a high level block diagram showing 5G cellular network with clusters.

FIG. 6 illustrates a block diagram of the system of FIG. 2 but further illustrating details of cluster configuration software, according to various embodiments.

FIG. 7 illustrates a method of establishing cellular communications using clusters.

FIG. 8 illustrates a block diagram of stretching the clusters from a public network to a private network, according to various embodiments.

FIG. 9 illustrates a method of establishing cellular communications using clusters stretched from a public network to a private network.

FIG. 10 illustrates a system with a centralized observability framework, according to various embodiments.

FIGS. 11 and 12 illustrate an overall architecture of an observability framework, according to various embodiments.

### DETAILED DESCRIPTION

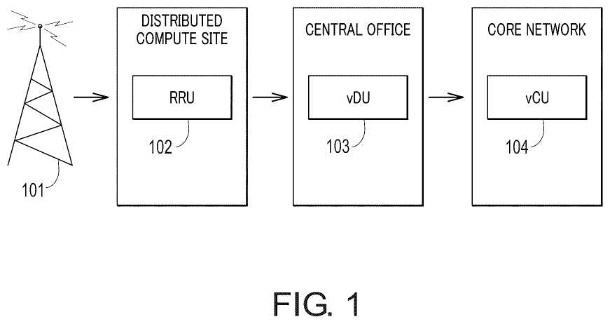

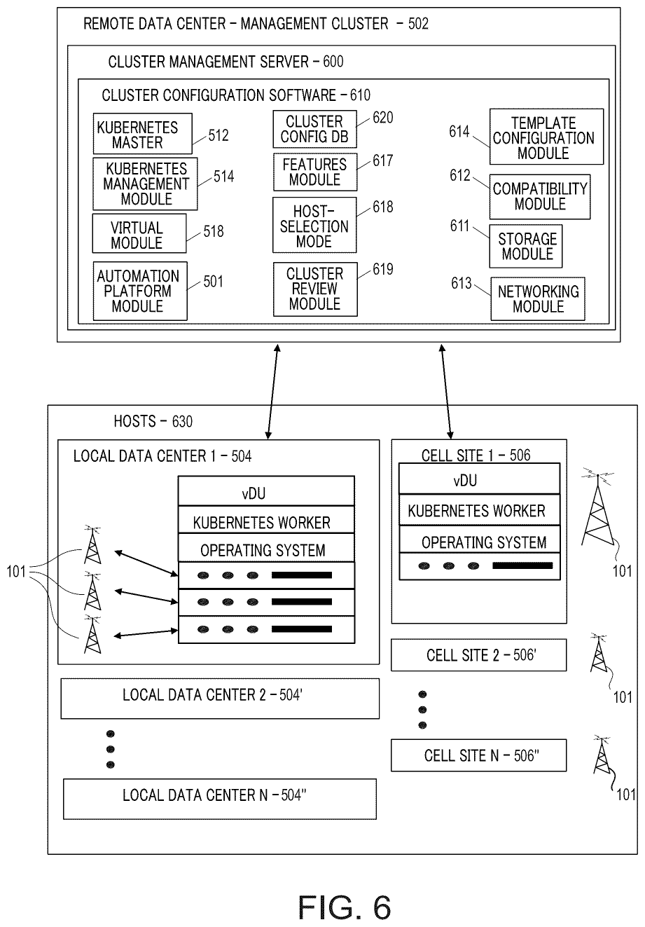

As shown in FIG. 1, a radio access network (RAN) includes a tower 101, radio unit (RU) (or remote radio unit (RRU)) 102, distributed unit (DU) (or virtualized distributed unit vDU, as shown) 103, central unit (CU) (or virtualized central unit vCU, as shown) 104, and an element management system (EMS) (not shown). FIG. 6 illustrates a system that delivers full RAN functionality using network functions virtualization (NFV) infrastructure. This approach decouples baseband functions from the underlying hardware and creates a software fabric. Within the solution architecture, virtualized baseband units (vBBU) process and dynamically allocate resources to remote radio units (RRUs) based on the current network needs. Baseband functions are split between central units (CUs) and distributed units (DUs) that can be deployed in aggregation centers or in central offices using a distributed architecture, such as using containerized applications (for example Kubernetes clusters) as discussed herein.

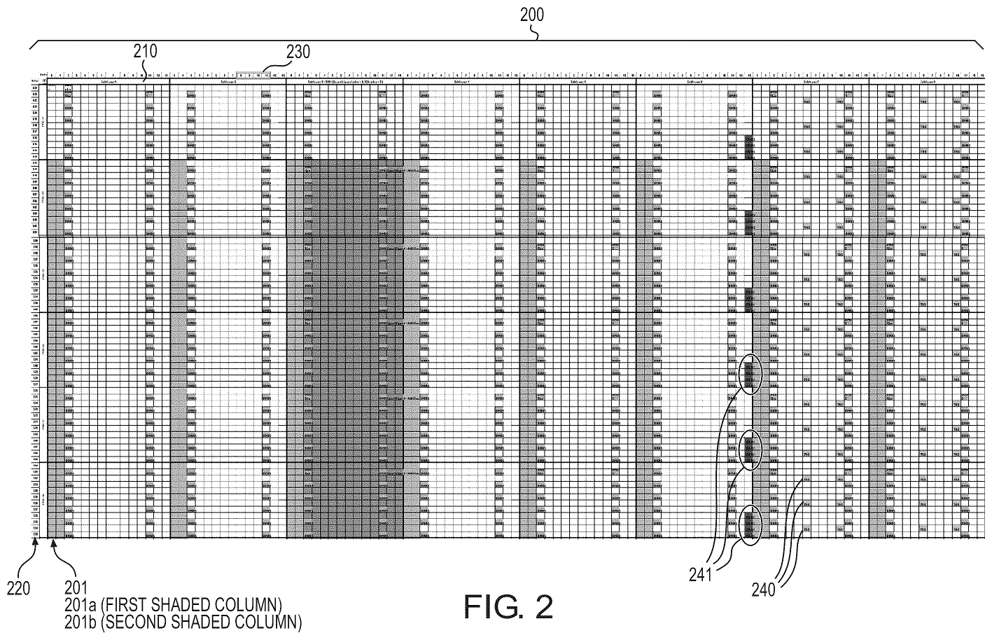

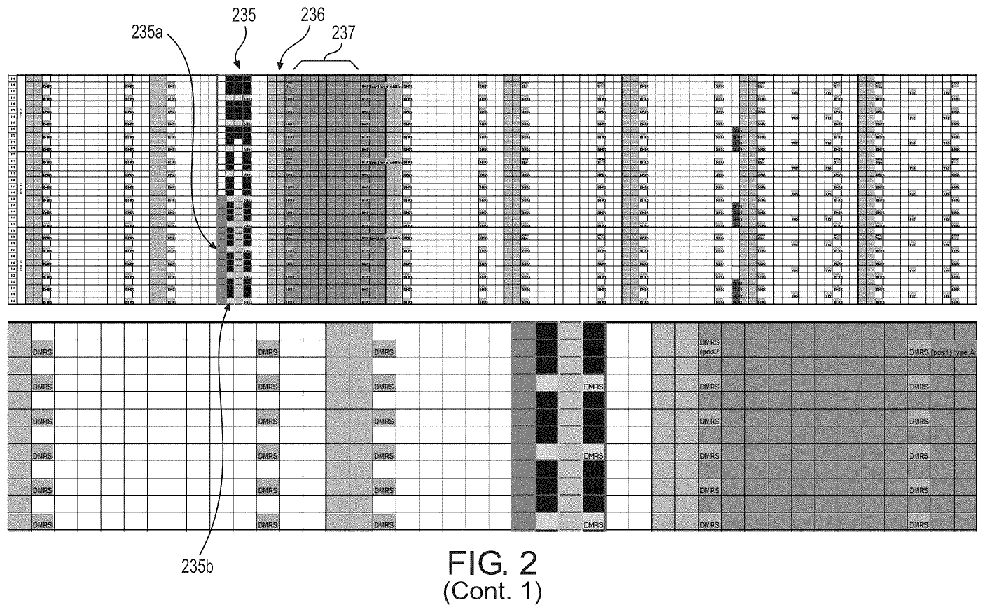

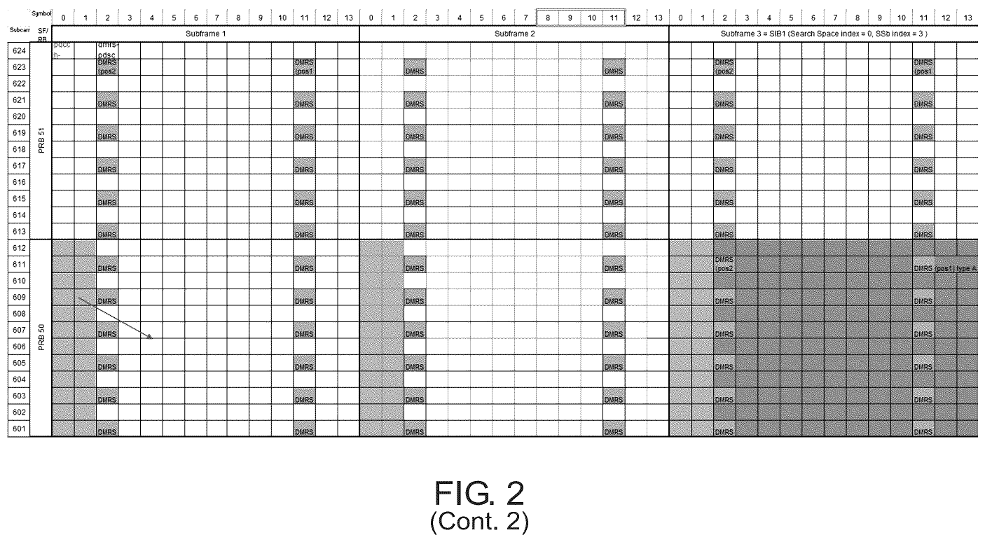

FIG. 2 shows an exemplary system for transfer of data packets within an infrastructure for a carrier, such as a wireless communication carrier. In the leftmost column, a list of subcarrier numbers (e.g., 624 to 553, inclusive) for a 10 MHz system are provided. The numbers are not so limited, and may exist from, for example, 624 to 1, as up to 624 subcarriers with, for example, 15 kHz spacing, may occur in a 10 MHz system.

Along the top row is a list of integer symbols. As a nonlimiting example, each subframe may have fourteen symbols (numbered 0-13, inclusive) which will amount to a normal cycle. The frame may be, for example, a 1 millisecond frame, though again is not so limited.

When data is sent from one location to another, there is a granular level at which the data is sent. One is the time domain (the horizontal axis within each subframe, 0-13 inclusive), which repeats. This repeats for each subframe and 10 repetitions (e.g., 10 subframes) may, for example, be considered one radio frame. The radio frames, as a whole, are continuously transmitted by the radio unit (RU), described in more detail later.

At the intersections of respective symbols and subcarriers within a particular subframe is a resource element. For example, in FIG. 2, at subframe 1, the intersection of symbol 0 and subcarrier 624 is a physical downlink control channel, or PDCCH, resource element. Thus, in each subframe, there exist 14 resource elements in the time domain (horizontally) and 12 resource elements for each physical resource block (PRB) in the frequency domain. Again, this is not so limited, as other numbers of resource elements within the time and frequency domain may be possible.

When data is to be sent, it may be sent across one symbol versus 12 subcarriers, which will provide a minimum granularity. The data may be sent to a user, such as a user of user equipment, via broadcast (e.g., unicast or multicast).

The signal through the PDCCH is a physical downlink control channel. As shown in FIG. 2, the highlighted portions of columns 0 and 1 from subchannels 612-601 amount to physical downlink allocations within a certain resource block, described in more detail later. Though not shown, there could be a similar allocation for an uplink allocation in the same frame.

The PDCCH will carry the downlink control information which will tell what resources exist in the downlink for a particular user or users, so the user(s) (via his/her user equipment) can identify that the data packet belongs to the appropriate user.

Embedded within the resource elements, for example the downlink control information but also in any other resource element, may exist particular access information to ensure that the user's user equipment is able to access the data for a particular time period, and under certain authentication conditions. For example, the system may allow for an automated check as to the authentication characteristics of the user, whether the user has accessed the data at the accessible time, and so on. Such a configuration may be controlled using cloud control, such as using a distributed unit (DU) and/or central unit (CU) distributed within a cloud network. The RUs may transmit the resource elements, which can then be broadcast periodically, e.g., for a predetermined time, and/or may repeat every period.

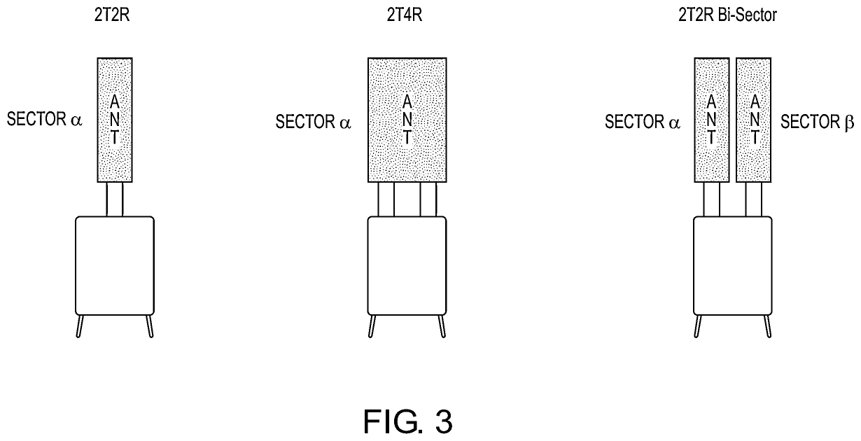

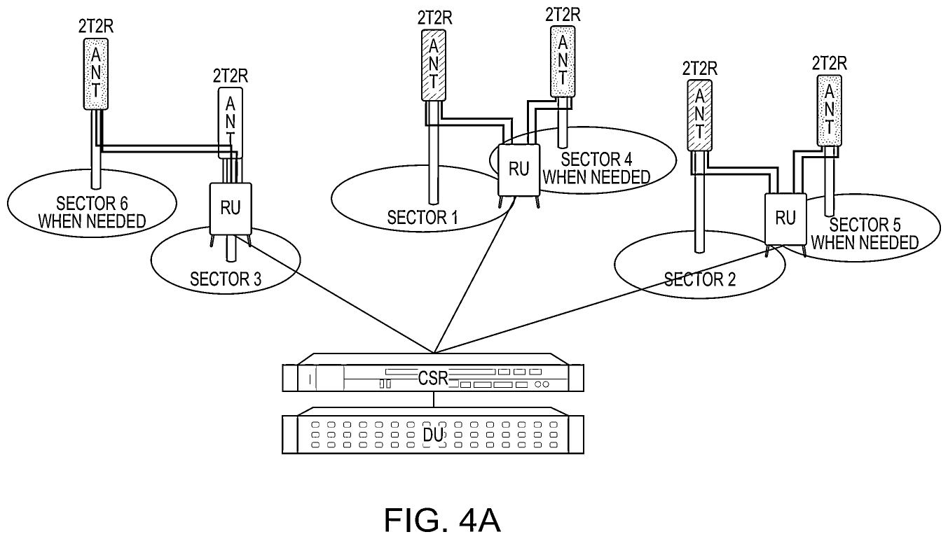

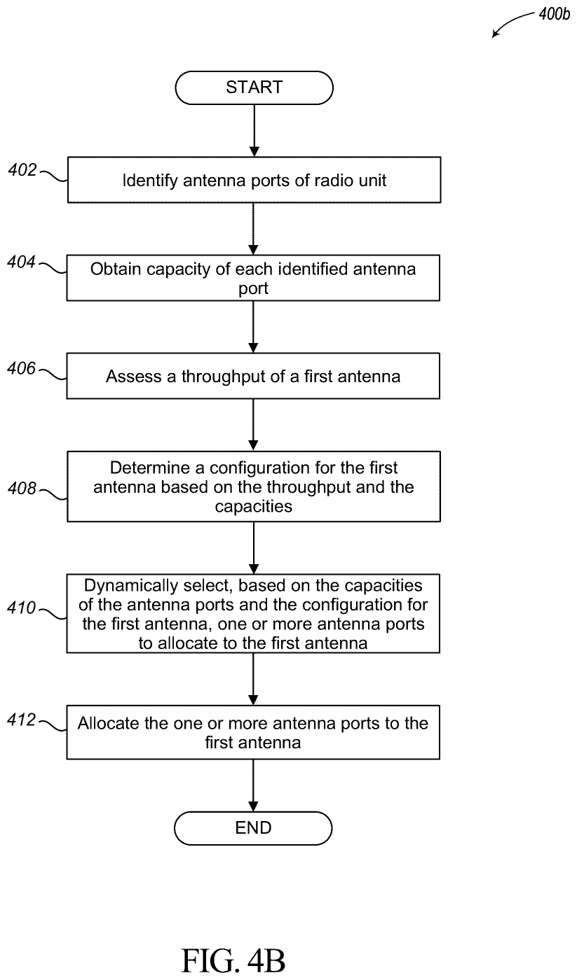

As shown in FIGS. 3 and 4, there are multiple radio units (RUs), or physical hardware on a tower, that connects to multiple antennas to transmit the data. The RUs each have multiple antenna ports. As in FIG. 4, the RUs may be connected to a cell site router (CSR), which is connected to a DU.

Each RU in some embodiments has multiple antenna ports, for example 4 antenna ports. These ports may provide information to the user equipment with respect to access to the data within the resource elements. Each antenna port is connected to its own amplifier to provide power to the antenna port. In some embodiments, the RUs described herein may be able to transmit and/or receive data at multiple frequencies.

In some embodiments, a configuration to reduce the number of antenna ports to turn on, thereby reducing power, can be achieved. Such a configuration may still allow access to the data for the user equipment, but the number of antenna ports on at a particular time may be dynamically adjusted to reduce power, taking into consideration current and/or expected load conditions.

As an example, in a 4T4R (4 transmit 4 receive) antenna system, which is a default in a 5G wireless configuration, the power requirements are rather high. By having the system, for example a cloud-based system, periodically and/or continuously check load by observing usage of the network, it can be determined whether the system, and particularly even the RU and/or antenna within the system, is generally in a no load or a low load condition. The low load condition may be defined as a load below a predetermined amount, such as when only a small number of users are using a particular part of the network or when only a minimal amount of data is being transferred at the particular part of the network. Nevertheless, a low load condition is a condition where a number of users, or an amount of data expected to be transmitted and/or received, is below a predetermined threshold. Similarly, a no load condition is when there are no users or no data being transferred at a particular time, in a particular location within the wireless communications network.

In some embodiments, the number of antenna ports within the 4T4R antenna system can be dynamically changed based upon the load condition. For example, the 4T4R antenna system can be changed to a 2T2R (2 transmit 2 receive) antenna system, with two transmitting and two receiving antenna ports turned off, when the system determines that it, or a particular part of the system (e.g., a part of the system using the subject antenna system), has a lower load condition or a no load condition, or when the system determines, based upon historical data, that a low load or no load condition is expected to shortly occur and/or is occurring. Alternatively, the system may instruct to turn off only two transmitting antenna ports, resulting in a 2T4R antenna system, for example in a case where maximum data receiving capability is needed, for example at a time where it is expected that the antenna will need to receive significant amounts of data, such as during maintenance or at a time of expected high receiving volume.

The instruction to reduce the number of antenna ports may come from within the RU or a locally hosted processor such as the CSR of FIG. 4, or from a cloud-hosted processor (e.g., within the DU or CU) that is connected (via the internet, fiber optical connection or otherwise) to the hardware of the antennas, RU and/or CSR. In any case, any processor of the RU, DU and CU may be utilized to observe, predict or otherwise assess current load and/or expected load or another predetermined variable, and, given the cooperation and communication between such processors, any one of such processors can instruct the antenna to turn off the required number of transmitting and/or receiving antenna ports in response to the load and/or predetermined variable being at a threshold amount. The predetermined variables may be, for example, number of users, resource block utilization, and others. This can be a dynamic action taking into consideration the processor's understanding of the variables observed, predicted and otherwise assessed using any of logic, machine learning, or preprogrammed algorithms, and can happen in real time or near real time. The processors may be locally hosted and connected only to specific aspects of the network, for example directly to antennas and/or RUs connected thereto, or may be part of a 5G cloud-based infrastructure, for example tied into the observability framework described later.

While the above describes reducing a number of antenna ports from a 4T4R antenna system to a 2T4R or 2T2R antenna system, in some cases, the reduction may be to a 3T3R, or 3T4R, or 4T3R system as well, though the number of ports will ideally be optimized to allow for transmission diversity and to allow for maximum transmission of data. In some embodiments, the reconfiguration can occur to an appropriate configuration taking into consideration MIMO (multiple input multiple output) and SISO (single input single output) requirements, as well as transfer diversity configuration based upon the set, recognized, or otherwise required load condition and thresholds.

FIG. 4A shows an example of a particular sector of the network (sector α) having the reduced antenna ports, such as a 2T2R antenna port, 2T4R antenna port, or, in a bi-sector antenna with sector β turned off, a 2T2R bi-sector antenna.

By reducing the transmission and reception configuration of antenna ports dynamically based upon the assessment of a no or low load condition, there can be an advantageous significant power reduction given that two power amplifiers (at least) would be turned off while still providing a sufficient amount of data transmit/reception ability to current or potential users. That is, in some embodiments, the amount of antenna port reduction that occurs to preserve power is balanced by the need for a satisfactory user experience, where, for example, a certain number of users may desire parallel transmission of data (via multiple transmitting antenna ports) in order to reduce latency, improve speed, and the like. Nevertheless, when below a predetermined number of users exists at a particular time, or is expected at a particular time, a number of antenna ports can be deactivated to save power while minimizing the decrease in user experience, either because there are very users are using the antenna at particular time, or because the users that are using the antennas do not require the use of a 4T4R antenna system for the amount of data that needs to be transmitted or received.

In some embodiments, a same processor provides instructions to increase or decrease the number of antenna ports (e.g., turn deactivated ports back on) or otherwise take an action to improve data transmission/reception capability. This, again, can be a dynamic action taking into consideration the processor's understanding of the variables observed, predicted and otherwise assessed using any of logic, machine learning, or preprogrammed algorithms, and can happen in real time or near real time.

In some embodiments, the system may take into consideration other variables, for example, variables relating to a number of RRC (radio resource control) connected users at a given time, or that may be expected at a given time based upon historical data. In such embodiments, the system may determine whether or not to turn off, or at least limit, supplemental downlink (SDL) ability. SDL is a configuration in which a frequency band is used for downlink-only traffic to support a conventional band running both uplink and downlink.

Such conventional bands with downlink and uplink may be, for example, FDD (frequency division duplexing) or TDD (time division duplexing), where a user can access, ask questions (provide data inputs) and receive a response (data output). These are mandatory channels, so as to allow communication happening from both the user side and the radio side.

An RRC connected user is a user that uses (via its user equipment) radio resource control connection. That is, once a user sees the cell, it is identified, and an action can be taken that requires additional data. The RRC is a control mechanism that can allow for data exchange can occur via dynamic configuration changes in order to allow for optional configuration at the time of communication.

When an SDL configuration is used, faster downloads may be achieved and a relatively larger number of users with mobile devices may be supported. This may be in a situation where, for example, additional downlink data is needed to be sent from the RU to the user (via the user equipment), and the SDL channels can thus be used by transmitting through the radio unit.

In some examples, if there are no users detected in the subject location, for example, a primary cell, the SDL will be requiring power given that its providing antenna ports are active and powered by their respective amplifiers, even though the SDL is not necessary, or is providing limited utility. That is, when there are no RRC users in the primary cell, the system may instruct, using the processors described heretofore, the antennas controlling the SDL to turn off all four of the antenna ports in the SDL, or at least some of the antenna ports in the SDL. Similarly, once an RRC connected user has arrived in the primary cell, the system, via the processors, can turn on some, or all, of the antenna ports powering the SDL. For example, based upon data requirements from the requests of the RRC connected user, the system may choose to increase from 0 to 2 ports, or 2 to 4 ports, saving power as much as possible while still allowing the RRC connected user to transmit and/or receive the necessary data.

In some embodiments, the system, via the processors described heretofore, can allow for transmission periodicity increases of SSB (Synchronization Signal Block) transmission in response to certain variables. Referring back to FIG. 2, signals are transmitted in the downlink across radio frames 200 (e.g., moving horizontally from one radio frame 200 to another, not shown). The radio frames include multiple subframes 200a, each separated by some time, for example 1 ms, with, for example, 10 subframes 200a (10 ms separation) for each radio frame 200. However, the number of subframes and time spacing between each subframe described above is only exemplary and is not so limited.

Along the left column are physical resource blocks 220 identifying subcarriers. These resource blocks are allocated to a user based upon usage requirements (e.g., data demand). For example, one user may require only 10 Kbps and be allocated only some resource blocks as shown in FIG. 2, while others may require 20 Kbps and may require more resource blocks. Shaded along the left are physical downlink control channels (PDCCH) 201. These PDCCHs 201 are where control information is available, for example information about which radio frame the user needs to read and in which resource block to read.

A static allocation of these PDCCHs and generally of control resources may occur. For example, when more users are present, they can be allocated to a particular subframe. For example, the resources can be allocated where they can serve two users, or perhaps even 4, or 6, or 10 or more, every subframe, based upon available bandwidth. The PDCCHs may be provided with two symbols 201a, 201b as shown in FIG. 2.

Since it is a static allocation, the PDCCH may be initially set to have two, symbols. In some embodiments, this can be dynamically changed based upon need, thereby allowing for power reduction. This may again utilize the processors described above. For example, power can be saved on uplink because the user will not need to read all the symbols when it is broadcast, and the user thus only needs to read one symbol. Once the symbol is fully utilized, the system, via the processors, can dynamically change to turn back on the second symbol. This can also save power even in the RU because transmission in two symbols is not required, as it can be transferred in only one symbol until that symbol is fully utilized.

Further, the PDCCHs can be transmitted in all four antenna ports (e.g., 4T), or even in 2 antenna ports (2T), or even with just one transmitting antenna port (1T). Transmitting in 1T may further save power during download.

While PDCCH signals are described above, other signals can similarly be transmitted through 2T or 1T when requirements are below a particular threshold.

Referring again to FIG. 2, numbers 8, 9, 10 and 11 of subframe 2 are grouped as unit 230. Moving vertically down the resource blocks 220, eventually additional signals, particularly synchronization signal blocks (SSB) 235, are provided. These SSB 235 are the first signal that the user (via user equipment) will read from the base station, and may be comprised of a primary synchronization signal 235a and a secondary synchronization signal 235b. The user (via the user equipment) will look for these signals and determine whether the blocks are accessible. In some situations, the SSB may not be accessible directly, but by a roaming partner or the like.

The SSB 235 may indicate broadcast information to that the next adjacent blocks 236, which may be system information blocks (SIB), and ultimately to a master information block (MIB) 237. In some situations, this data can be transmitted through just one antenna port even when there are two antenna ports active. Accordingly, the processors can dynamically change a number of ports for PDCCH, SSB, and SIB broadcast based upon efficient energy utilization, given that the user equipment can efficiently determine which ports to search. This can again be particularly useful in a low load situation where coverage does not need to be enhanced. Further, interference can be reduced by having less antenna ports open during this data transmission, thus allowing for an additional advantage. Transmitting PDCCH and SSB and SIB information on relatively fewer antenna ports will improve energy saving and avoid interference.

Additionally, the SDL cell, which may be a coverage cell provided by the antenna connected to an RU, may not necessarily need SIB transmission. Thus, there can be dynamical turning off of SIB information in the supplemental downlink, to avoid having to transmit SIB1 to SDL cells when it would otherwise be of no use.

Additionally or alternatively, transmission of the SSB 235 may be transmitted with a particular periodicity, such as 5 ms, 10 ms, up to 160 ms. In the primary cell, there may be a periodicity of 20 ms which may be required in a regular primary cell. That is, every 20 ms there is a transmission. But under certain situations, such as no load or low load conditions and/or a lack of RDC connected users or the like, the periodicity of the SSB transmission for the SDL cell may be reduced (e.g., from 20 ms to 40 ms, or to even 80 ms or 160 ms or the like), which may provide yet another avenue for power saving.

In some examples, in a no user condition, the SDL may be turned off entirely, while in a low user condition, the SDL may be turned on, with an increased periodicity. Further, even when the periodicity is increased, certain symbols may still be available for data transmission, which can allow for increased capacity while still lowering power requirements.

In some embodiments, either in addition to or instead of changing characteristics of the SDL, the primary cell bandwidth can also be changed dynamically, by the same processor discussed above, in response to no or low load conditions. Referring back to FIG. 2, there may exist hundreds or even thousands of subcarriers. By dynamically changing bandwidth, for example, from 15 MHz to 5 Mhz, power saving may occur without negatively affecting usage.

In some embodiments, when a cell does not have an RRC connected user, further actions can be taken to minimize power output. For example, three exists a channel state information reference signal (CSIRS) transmission that is generally, in most systems, always turned on based on the static CSI Measurement set up configuration in all physical resource blocks across an entire channel bandwidth (e.g., 5 MHz, 10 MHz, 15 MHz, and so on up to 100 MHz in a first frequency). However, this may not be necessary in order to still achieve acceptable functionality. A CSIRS may be particularly useful to report channel quality information in uplink, which is particularly desirable when a RRC connected user is present, in order for the base station (e.g., gnodeB) to allocate resource blocks to appropriate users.

Referring again to FIG. 2, a determination of where signals are located can be made by finding tracking reference signals (TRS) 240. A TRS may be desirable to aid in tracking when a connected (RRC connected) user is having difficulty taking an action such as transmitting or receiving data. The channel state information reference signals (CSIRS) 241, with the TRS and CSIRS available across various reference blocks. However, in a state where there are no, or limited (e.g., below a predetermined threshold) RRC connected users within a specific point in the system, such as within a primary cell or within a frame or within some other cell or portion of the cellular network, one or both of the TRS 240 and CSIRS 241 can be turned off. This may be executed by the processors described above.

This may achieve further power saving while still having an optimized network where when RRC connected users join the requisite cells or other predetermined locations, the TRS and/or CSIRS can be dynamically turned on in order to allow for the appropriate measuring and/or tracking afforded by such reference signals.

Additionally or alternatively, in a state where there are no, or limited (e.g., below a predetermined threshold) RRC connected users within a specific point in the system, such as within a primary cell or within a frame or within some other cell or portion of the cellular network, the CSIRS and/or TRS configuration can be scaled down by increasing the periodicity thereof. It can also be scaled up when a predetermined number of RRC connected users enter the point.

Further, a number of resource blocks can be dynamically changed in response to a number of RRC connected users, which can affect a bandwidth change for the CSIRS. Similarly, this can occur to affect a bandwidth change for the TRS.

FIG. 4B illustrates a logical flow diagram showing one embodiment of a process 400b for dynamically allocating capacity of a radio unit to one or more antennas. Process 400b starts, after a start block, at block 402, where antenna ports of the radio unit are identified. After block 402, process 400b continues to block 404.

At block 404, a capacity of each identified antenna port of the radio unit is obtained. In some embodiments, obtaining the capacity for each of the antenna ports includes obtaining a maximum bandwidth for each of the antenna ports. For example, an antenna port of the radio unit may support a maximum bandwidth of 10 Gigabits per second. In some embodiments, obtaining the capacity of each of the antenna ports includes obtaining an available bandwidth of each of the antenna ports. After block 404, process 400b continues to block 406.

At block 406, a throughput of a first antenna is assessed. In some embodiments, the first antenna is installed at a cell site, and the throughput is a current bandwidth utilization of the first antenna. For example, the first antenna may have a current bandwidth utilization of 25 Gigabits per second. In some embodiments, the first antenna is not installed at the cell site. In some such embodiments, the assessed throughput of the first antenna is an anticipated bandwidth utilization of the first antenna. For example, the anticipated bandwidth utilization of the first antenna may be based on utilizations of one or more antennas associated with sectors that overlap with a sector to be served by the first antenna when it is installed. In some embodiments, the throughput is assessed using a moving average or other statistical measure. In some embodiments, the throughput is a maximum throughput in a previous time period, such as a previous minute, hour, day, week, etc. The throughput may also be a percentile of throughput in a previous time period, such as a 90^{th} percentile of throughput. In various embodiments, the assessed throughput may be a transmitting bandwidth utilization, a receiving bandwidth utilization, both a transmitting and receiving bandwidth utilization, or a combination thereof. After block 406, process 400b continues to block 408.

At block 408, a configuration for the first antenna is determined based on the throughput and the capacities. In some embodiments, the configuration includes a number of transmitting antenna ports and a number of receiving antenna ports. For example, the first antenna may be configured as a 4T4R (4 transmit and 4 receive) antenna. In various embodiments, the first antenna may also be configured as a 4T2R, 2T4R, 4T2R, 2T2R, or 0T0R (off) antenna based on the assessed throughput. In some embodiments, typically wherein the throughput is less than a capacity of a current configuration of the first antenna, a transmitting configuration is determined by dividing a transmitting throughput of the first antenna by a capacity a radio unit antenna port, yielding a number of radio unit antenna ports required to service the transmitting throughput of the first antenna. For example, if the first antenna is being operated in a 4T4R configuration with a transmitting throughput of 25 Gigabits per second and a capacity of each radio unit antenna port is 10 Gigabits per second, the number of ports is required to service the transmitting throughput is 2.5. Because configurations are typically quantized into discrete configurations of ports such as 2T2R or 4T4R, a transmitting throughput requiring a capacity of 2.5 transmitting antenna ports may be configured to use 4 transmitting antenna ports. Similarly, an antenna with a receiving throughput requiring 0.5 ports may be configured to use 2 receiving ports.

In some embodiments, typically wherein a utilization of an allocated capacity to the first antenna exceeds a utilization threshold, the configuration may be increased to include more antenna ports as compared to a current configuration of the first antenna. For example, if the first antenna is currently a 2T2R antenna utilizing 90%, 95%, or 100%, etc., of its allocated transmitting capacity, the configuration may be determined to be 4T2R configuration. Similarly, if the first antenna is currently a 2T2R antenna utilizing 90%, 95%, or 100% of its currently allocated capacity, the configuration may be determined to be a 2T4R configuration.

In some embodiments, the first antenna may be currently turned off. In response to turning the first antenna on, a default configuration may be determined such as 2T2R or 4T4R.

In some embodiments, the configuration for the first antenna is based on a variability of the throughput. For example, if the typical throughput of the first antenna may be serviced by a 2T2R configuration but the throughput frequently requires a 4T4R configuration, the configuration may be determined to be a 4T4R configuration.

In some embodiments, a fractional port requirement such as.5 ports is provided by modulating a duty cycle of an antenna port. For example, capacity equivalent to.5 antenna ports may be achieved by operating an antenna port at 50% duty cycle. In some embodiments, fractional portions of capacity of an antenna port may be allocated to two or more antennas, such as by operating the antenna at 50% duty cycle for each of two antennas.

At block 410, one more antenna ports are dynamically selected to allocate to the first antenna based on the obtained capacity of each antenna port of the radio unit and the first antenna configuration. As discussed herein, a cell site may contain many antennas and many radio units and radio unit antenna ports. In some embodiments, the cell site is configured such that antenna port connections may be switched between two or more antennas. For example, a radio unit antenna port may be connected to a plurality of antennas using a switch such that the antenna port may communicate with a selected antenna of the plurality of antennas. Thus, in a cell site there may be many combinations of transmitting and receiving antenna ports between radio units that could be allocated to implement the configuration of the first antenna. For example, a 4T4R configuration for the first antenna may be implemented using a 2T2R configuration of antenna ports of a first radio unit and a 2T2R configuration of antenna ports of a second radio unit. Thus, the first antenna may be connected to antenna ports of two or more radio units. In general, the one or more antenna ports to allocate are selected to reduce power consumption of the cell site while maintaining cell site capacity sufficient to serve cell site traffic.

In various embodiments, the one or more antenna ports are selected to allocate to the first antenna based on available bandwidth of the antenna ports. For example, if each antenna port of a radio unit is already allocated to an antenna, antenna ports with high available bandwidth may be selected as the one or more antenna ports to allocate to the first antenna.

In some embodiments, the one or more antenna ports may include an antenna port that is already allocated to the first antenna. For example, if an antenna is currently configured as a 2T2R antenna and it is determined that the first antenna is to be configured as a 4T4R antenna, the antennas currently used in the 2T2R configuration may be selected as a portion of the one or more antenna ports. In some embodiments, the one or more antenna ports do not include an antenna port that is already allocated to the first antenna. For example, if the first antenna is currently off and has no currently allocated radio unit antenna ports, the one or more antenna ports may be allocated from radio unit antenna ports not allocated to an antenna, or from radio unit antenna ports currently allocated to other antennas. After block 408, process 400b continues to block 410.

At block 410, the one or more antenna ports are allocated to the first antenna. In some embodiments, antenna ports of the radio unit that are not allocated to the first antenna are entered into a reduced-power state. In various embodiments, the antenna ports of the radio unit are entered into a reduced-power state by turning the antenna ports off, entering the antenna ports into sleep mode, turning off one or more antenna amplifiers connected to the antenna ports, etc. In some embodiments, the antenna ports of the radio unit that are not allocated to the first antenna are allocated to a second antenna. In some embodiments, allocating the one or more antenna ports to the first antenna includes connecting an antenna port in the one or more antenna ports to an antenna amplifier corresponding to the first antenna. In some such embodiments, a switch is used to connect the antenna port to the antenna amplifier. After block 410, process 400b ends at an end block.

While process 400b is discussed herein in terms of selecting one or more antenna ports to allocate to single antenna, the disclosure is not so limited. In various embodiments of process 400b, sets of ports are selected to allocate to two or more antennas. For example, a first set of antenna ports of a radio unit may be allocated to a first antenna, and a second set of antenna ports of the radio unit may be allocated to a second antenna. In some embodiments, an antenna port that is allocated to a second antenna is turned off. In some such embodiments, the antenna port to turn off is selected based on determining that a sector served by the second antenna in communication with the antenna port overlaps with at least a portion of a sector served by the first antenna. Thus, an RRC connected user previously served by the second antenna may be served by the first antenna when an allocated capacity of the second antenna is reduced. In some embodiments, an antenna port allocated to the second antenna that is currently turned off is turned on in response to determining that a throughput of the first antenna exceeds a threshold, and that a sector served by the first antenna overlaps with a sector served by the second antenna.

Moreover, embodiments of process 400b may be used to determine a number of radio units to install or maintain at a cell site. For example, if it is determined that a combined anticipated throughput of 6 antennas to be installed at a cell site may be met by allocating antenna ports of 4radio units to the 6 antennas, 4 radio units may be installed at the cell site. This may reduce a number of radio units installed at the cell site while supporting a same number of antennas. Similarly, process 400b may be used to determine connections between the various radio units and antennas based on the determined radio unit antenna port allocations.

Using techniques described herein, a variety of advantages may be realized. By implementing split-sector cell sites, a total number of radio units at the cell site may be reduced. Thus, the cell site may be smaller, lighter, or have lower power requirements. A number of supported sectors may be increased without requiring additional radio units. Runtime in battery backup mode may also be improved due to decreased power consumption.

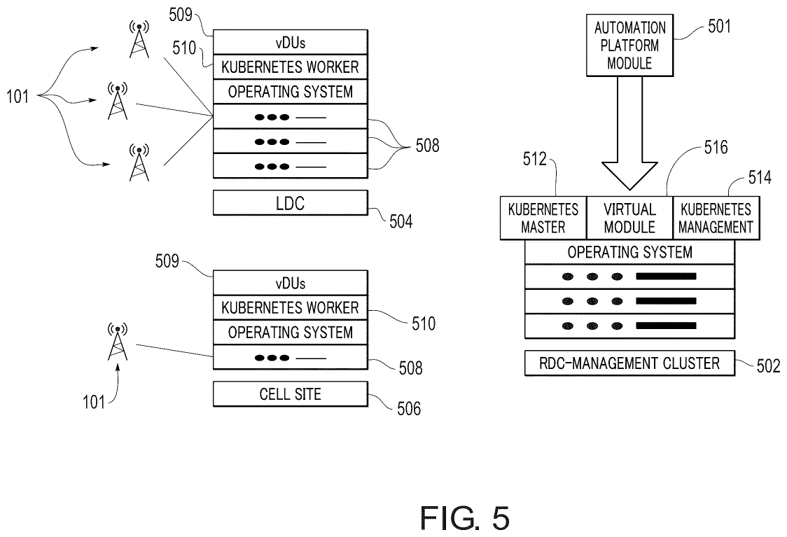

FIG. 5 illustrates a logical flow diagram showing one embodiment of a process 500 for determining a physical configuration for a cell. As described herein, cells or cell components may be entered into reduced-power states to reduce operational expenses. In some embodiments, a physical configuration of a cell is altered in addition to or instead of entering a reduced-power state. For example, antennas in a cell are typically configured as 4T4R antennas, with four actively transmitting ports and four actively receiving ports, with each port connected to a radio unit. In some embodiments, a demand for coverage in an area may not warrant a 4T4R configuration, a dedicated sector, etc. For example, a peak transmit bandwidth of an area may consume a fraction of a bandwidth capacity of a single transmit port. Thus, an installed capacity of a cell site may be fine-tuned according to anticipated or actual coverage demand, reducing capital expenditure and power consumption.

As discussed herein, various components of a cell such as the central unit or the distributed unit may be implemented using containerized applications. This may provide benefits such as autoscaling, reducing hardware components that are located at a cell site, and improving serviceability and resiliency of the cell. Implementing components of the cell using containerized applications provides further flexibility for reducing power consumption of the cell, as containerized application capacity may be easily reduced in low-load or no-load scenarios.

The containerized application can be any containerized application but is described herein as Kubernetes clusters for ease of illustration, but it should be understood that the present invention should not be limited to Kubernetes clusters and any containerized applications could instead be employed. In other words, the below description uses Kubernetes clusters and exemplary embodiments but the present invention should not be limited to Kubernetes clusters.

The dynamic determinations described above can occur within a cellular network using Kubernetes clusters. As such, various embodiments provide running Kubernetes clusters along with a radio access network (“RAN”) to coordinate workloads in the cellular network, such as a 5G cellular network. Broadly speaking, embodiments of the present invention provide methods, apparatuses and computer implemented systems for providing data for observability on a 5G cellular network using servers at cell sites, cell towers and Kubernetes clusters that stretch from a public network to a private network.

A Kubernetes cluster may be part of a set of nodes that run containerized applications. Containerizing applications is an operating system-level virtualization method used to deploy and run distributed applications without launching an entire virtual machine (VM) for each application.

Cluster configuration software is available at a cluster configuration server. This guides a user, such as a system administrator, through a series of software modules for configuring hosts of a cluster by defining features and matching hosts with requirements of features so as to enable usage of the features in the cluster. The software automatically mines available hosts, matches host with features requirements, and selects the hosts based on host-feature compatibility. The selected hosts are configured with appropriate cluster settings defined in a configuration template to be part of the cluster. The resulting cluster configuration provides an optimal cluster of hosts that are all compatible with one another and allows usage of various features. Additional benefits can be realized based on the following detailed description.

The present application uses such containerized applications (e.g., Kubernetes clusters) to deploy a RAN so that the vDU of the RAN is located at one Kubernetes cluster and the vCU is located at a remote location from the vDU. This configuration allows for a more stable and flexible configuration for the RAN.

Virtualized CUs and DUs (vCUs and vDUs) run as virtual network functions (VNFs) within the NFV infrastructure. The entire software stack that is needed is provided for NFV, including open-source software. This software stack and distributed architecture increases interoperability, reliability, performance, manageability, and security across the NFV environment.

RAN standards require deterministic, low-latency, and low-jitter signal processing. These may be achieved using containerized applications (e.g., Kubernetes clusters) to control each RAN. Moreover, the RAN may support different network topologies, allowing the system to choose the location and connectivity of all network components. Thus, the system allowing various DUs on containerized applications (e.g. Kubernetes clusters) allows the network to pool resources across multiple cell sites, scale capacity based on conditions, and ease support and maintenance requirements.

FIG. 5 illustrates an exemplary system used in constructing clusters that allows a network to control cell sites, in one embodiment of the invention. The system includes a cluster configuration server that can be used by a cell site to provide various containers for processing of various functions. Each of the cell sites are accessed via at least one cellular tower (and RRU) by the client devices, which may be any computing device which has cellular capabilities, such as a mobile phone, computer or other computing device.

As shown, the system includes an automation platform (AP) module 501, a remote data center (RDC) 502, one or more local data centers (LDC) 504, and one or more cell sites 506.

The cell sites provide cellular service to the client devices through the use of a vDU 509, server 508, and a cell tower 101. The server 508 at a cell site 506 controls the vDU 509 located at the cell site 506, which in turn controls communications from the cell tower 101. Each vDU 509 is software to control the communications with the cell towers 507, RRUs, and CU so that communications from client devices can communicate from one cell tower 507 through the clusters (e.g. Kubernetes clusters) to another cell tower 707. In other words, the voice and data from a cellular mobile client device connects to the towers and then goes through the vDU to transmit such voice and data to another vDU to output such voice and data to another tower 507.

The server(s) on each individual cell site 506 or LDC 504 may not have enough computing power to run a control plane that supports the functions in the mobile telecommunications system to establish and maintain the user plane. As such, the control plane is then run in a location that is remote from the cell sites 506, such as the RDC.

The RDC 502 is the management cluster which manages the LDC 504 and a plurality of cell sites 506. As mentioned above, the control plane may be deployed in the RDC 502. The control plane maintains the logic and workloads in the cell sites from the RDC 502 while each of the containerized applications (e.g., Kubernetes containers) is deployed at the cell sites 506. The control plane also monitors the workloads to ensure they are running properly and efficiently in the cell sites 506 and fixes any workload failures. If the control plane determines that a workload fails at the cell site 506, for example, the control plane redeploys the workload on the cell site 506.

The RDC 502 may include a master 512 (e.g., a Kubernetes master or Kubernetes master module), a management module 514 and a virtual (or virtualization) module 516. The master module 512 monitors and controls the workers 510 (also referred to herein as Kubernetes workers, though workers of any containerized applications are within the scope of this feature) and the applications running thereon, such as the vDUs 509. If a vDU 509 fails, the master module 512 recognizes this, and will redeploy the vDU 509 automatically. In this regard, the Kubernetes clusters system has intelligence to maintain the configuration, architecture and stability of the applications running. As such, the Kubernetes clusters system may be considered to be “self-healing”.

The management module 514 along with the Automation Platform 501 creates the Kubernetes clusters in the LDCs 504 and cell sites 506.

For each of the servers 508 in the LDC 504 and the cell sites 506, an operating system is loaded in order to run the workers 510. For example, such software could be ESKi and Photon OS. The vDUs are also software, as mentioned above, that runs on the workers 510. In this regard, the software layers are the operating system, and then the workers 510, and then the vDUs 509.

The automation platform module 501 includes a graphical user interface (GUI) that allows a user to initiate clusters. The automation platform module 501 communicates with the management module 514 so that the management module 514 creates the clusters and a master module 512 for each cluster.

Prior to creating each of the clusters, the virtualization module 516 creates a virtual machine (VM) so that the clusters can be created. VMs and containers are integral parts of the containerized applications (e.g., Kubernetes clusters) infrastructure of data centers and cell sites. VMs are emulations of particular computer systems that operate based on the functions and computer architecture of real or hypothetical computers. A VM is equipped with a full server hardware stack that has been virtualized. Thus, a VM includes virtualized network adapters, virtualized storage, a virtualized central processing unit (CPU), and a virtualized BIOS. Since VMs include a full hardware stack, each VM requires a complete operating system (OS) to function, and VM instantiation thus requires booting a full OS.

In addition to VMs, which provide abstraction at the physical hardware level (e.g., by virtualizing the entire server hardware stack), containers are created on top of the VMs. Containers Application presentation systems create a segmented user space for each instance of an application. Applications may be used, for example, to deploy an office suite to dozens or thousands of remote workers. In doing so, these applications create sandboxed user spaces on a server for each connected user. While each user shares the same operating system instance including kernel, network connection, and base file system, each instance of the office suite has a separate user space.

In any event, once the VMs and containers are created, the master modules 512 then create a vDU 509 for each VM.

The LDC 504 is a data center that can support multiple servers and multiple towers for cellular communications. The LDC 504 is similar to the cell sites 506 except that each LDC has multiple servers 508 and multiple towers 101. Each server in the LDC 504 (as compared with the server in each cell site 506) may support multiple towers. The server 508 in the LDC may be different from the server 508 in the cell site 506 because the servers 508 in the LDC are larger in memory and processing power (number of cores, etc.) relative to the servers in the individual cell sites 506. In this regard, each server 508 in the LDC may run multiple vDUs (e.g., 2), where each of these vDUs independently operates a cell tower 707. Thus, multiple towers 101 can be operated through the LDCs 504 using multiple vDUs using the clusters. The LDCs 504 may be placed in bigger metropolitan areas whereas individual cell sites 506 may be placed at smaller population areas.

FIG. 6 illustrates a block diagram of the system of FIG. 5, while further illustrating details of cluster configuration software, according to various embodiments.

As illustrated, a cluster management server 600 is configured to run the cluster configuration software 610. The cluster configuration software 610 runs using computing resources of the cluster management server 600. The cluster management server 600 is configured to access a cluster configuration database 620. In one embodiment, the cluster configuration database 620 includes a host list with data related to a plurality of hosts 630 including information associated with hosts, such as host capabilities. For instance, the host data may include list of hosts 630 accessed and managed by the cluster management server 600, and for each host 630, a list of resources defining the respective host's capabilities. Alternately, the host data may include a list of every host in the entire virtual environment and the corresponding resources or may include only the hosts that are currently part of an existing cluster and the corresponding resources. In an alternate embodiment, the host list is maintained on a server that manages the entire virtual environment and is made available to the cluster management server 600.

In addition to the data related to hosts 630, the cluster configuration database 620 includes features list with data related to one or more features including a list of features and information associated with each of the features. The information related to the features include license information corresponding to each feature for which rights have been obtained for the hosts, and a list of requirements associated with each feature. The list of features may include, for example and without limitations, live migration, high availability, fault tolerance, distributed resource scheduling, etc. The list of requirements associated with each feature may include, for example, host name, networking and storage requirements. Information associated with features and hosts are obtained during installation procedure of respective components prior to receiving a request for forming a cluster.

Each host is associated with a local storage and is configured to support the corresponding containers running on the host. Thus, the host data may also include details of containers that are configured to be accessed and managed by each of the hosts 830. The cluster management server 800 is also configured to access one or more shared storage and one or more shared network.

The cluster configuration software 610 includes one or more modules to identify hosts and features and manage host-feature compatibility during cluster configuration. The configuration software 610 includes a compatibility module 612 that retrieves a host list and a features list from the configuration database 620 when a request for cluster construction is received from the client. The compatibility module 612 checks for host-feature compatibility by executing a compatibility analysis which matches the feature requirements in the features list with the hosts capabilities from the host list and determines if sufficient compatibility exists for the hosts in the host list with the advanced features in the features list to enable a cluster to be configured that can utilize the advanced features. Some of the compatibilities that may be matched include hardware, software and licenses.

It should be noted that the aforementioned list of compatibilities are exemplary and should not be construed to be limiting. For instance, for a particular advanced feature, such as fault tolerance, the compatibility module checks whether the hosts provide a compatible processor family, host operating system, Hardware Virtualization enabled in the BIOS, and so forth, and whether appropriate licenses have been obtained for operation of the same. Additionally, the compatibility module 612 checks to determine if networking and storage requirements for each host in the cluster configuration database 620 are compatible for the selected features or whether the networking and storage requirements may be configured to make them compatible for the selected features. In one embodiment, the compatibility module checks for basic network requirements. This might entail verifying each host's connection speed and the subnet to determine if each of the hosts has the required speed connection and access to the right subnet to take advantage of the selected features. The networking and storage requirements are captured in the configuration database 820 during installation of networking and storage devices and are used for checking compatibility.

The compatibility module 612 identifies a set of hosts accessible to the cluster management server 600 that either matches the requirements of the features or provides the best match and constructs a configuration template that defines the cluster configuration settings or profile that each host needs to conform in the configuration database 620. The configuration analysis provides a ranking for each of the identified hosts for the cluster. The analysis also presents a plurality of suggested adjustments to particular hosts so as to make the particular hosts more compatible with the requirements. The compatibility module 612 selects hosts that best match the features for the cluster. The cluster management server 600 uses the configuration settings in the configuration template to configure each of the hosts for the cluster. The configured cluster allows usage of the advanced features during operation and includes hosts that are most compatible with each other and with the selected advanced features.

In addition to the compatibility module 612, the configuration software 610 may include additional modules to aid in the management of the cluster including managing configuration settings within the configuration template, addition/deletion/customization of hosts and to fine-tune an already configured host so as to allow additional advanced features to be used in the cluster. Each of the modules is configured to interact with each other to exchange information during cluster construction. For instance, a template configuration module 614 may be used to construct a configuration template to which each host in a cluster must conform based on specific feature requirements for forming the cluster. The configuration template is forwarded to the compatibility module which uses the template during configuration of the hosts for the cluster. The host configuration template defines cluster settings and includes information related to network settings, storage settings and hardware configuration profile, such as processor type, number of network interface cards (NICs), etc. The cluster settings are determined by the feature requirements and are obtained from the Features list within the configuration database 620.

A configuration display module may be used to return information associated with the cluster configuration to the client for rendering and to provide options for a user to confirm, change or customize any of the presented cluster configuration information. In one embodiment, the cluster configuration information within the configuration template may be grouped in sections. Each section can be accessed to obtain further information regarding cluster configuration contained therein.

A features module 617 may be used for mining features for cluster construction. The features module 617 is configured to provide an interface to enable addition, deletion, and/or customization of one or more features for the cluster. The changes to the features are updated to the features list in the configuration database 620. A host-selection module 618 may be used for mining hosts for cluster configuration. The host-selection module 618 is configured to provide an interface to enable addition, deletion, and/or customization of one or more hosts. The host-selection module 618 is further configured to compare all the available hosts against the feature requirements, rank the hosts based on the level of matching and return the ranked list along with suggested adjustments to a cluster review module 619 for onward transmission to the client for rendering.

The cluster review module 619 may be used to present the user with a proposed configuration returned by the host-selection module 618 for approval or modification. The configuration can be fine-tuned through modifications in appropriate modules during guided configuration set-up which are captured and updated to the host list in either the configuration database 620 or the server. The suggested adjustments may include guided tutorial for particular hosts or particular features. In one embodiment, the ranked list is used in the selection of the most suitable hosts for cluster configuration. For instance, highly ranked hosts or hosts with specific features or hosts that can support specific applications may be selected for cluster configuration. In other embodiments, the hosts are chosen without any consideration for their respective ranks. Hosts can be added or deleted from the current cluster. In one embodiment, after addition or deletion, the hosts are dynamically re-ranked to obtain a new ranked list. The cluster review module 612 provides a tool to analyze various combinations of hosts before selecting the best hosts for the cluster.

A storage module 611 enables selection of storage requirements for the cluster based on the host connectivity and provides an interface for setting up the storage requirements. Shared storage is required in order to take advantage of the advanced features. As a result, one should determine what storage is shared by all hosts in the cluster and use only those storages in the cluster in order to take advantage of the advanced features. The selection options for storage include all the shared storage available to every host in the cluster. The storage interface provides default storage settings based on the host configuration template stored in the configuration database 620 which is, in turn, based on compatibility with prior settings of hosts, networks and advanced features and enables editing of a portion of the default storage settings to take advantage of the advanced features. In one embodiment, if a required storage is available to only a selected number of hosts in the cluster, the storage module will provide necessary user alerts in a user interface with required tutorials on how to go about fixing the storage requirement for the configuration in order to take advantage of the advanced features. The storage module performs edits to the default storage settings based on suggested adjustments. Any updates to the storage settings including a list of selected storage devices available to all hosts of the cluster are stored in the configuration database 620 as primary storage for the cluster during cluster configuration.

A networking module 613 enables selection of network settings that is best suited for the features and provides an interface for setting up the network settings for the cluster. The networking module provides default network settings, including preconfigured virtual switches encompassing several networks, based on the host configuration template stored in the cluster configuration database, enables selecting/editing the default network settings to enter specific network settings that can be applied/transmitted to all hosts, and provides suggested adjustments with guided tutorials for each network options so a user can make informed decisions on the optimal network settings for the cluster to enable usage of the advanced features. The various features and options matching the cluster configuration requirements or selected during network setting configuration are stored in the configuration database and applied to the hosts so that the respective advanced features can be used in the cluster.

FIG. 6 also illustrates cell sites 506 that are configured to be clients of each cluster. Each cell site 506 includes a cell tower 101 and a connection to each distributed unit (DU), similar to FIG. 5. Each DU is labeled as a virtualized distributed unit (vDU) 509, similar to FIG. 5, and each vDU runs as virtual network functions (VNFs) within an open source network functions virtualization (NFV) infrastructure.

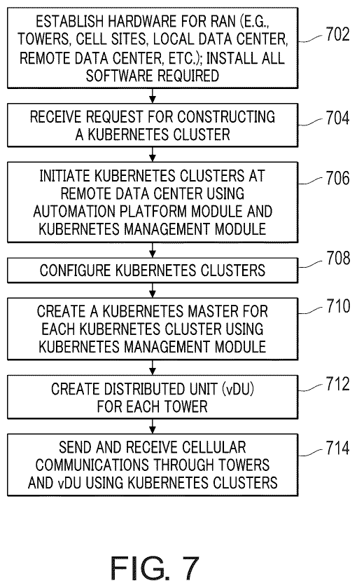

With the above overview of the various components of a system used in the cluster configuration, specific details of how each component is used in establishing and communicating through a cellular network using containerized applications such as Kubernetes clusters, as shown in FIG. 7.

First, all of the hardware required for establishing a cellular network (e.g., a RAN, which includes towers, RRUs, DUs, CU, etc.) and a cluster (e.g., servers, workers, racks, etc.) are provided, as described in block 702. The LDC 504, RDC 502, and cell sites 506 are created and networked together via a network.

In blocks 702-714, the process of constructing a cluster using a plurality of hosts will now be described.

The process begins at block 704 with a request for constructing a cluster from a plurality of hosts which support one or more containers. The request is received at the automation platform module 501 from a client. The process of receiving a request for configuring a cluster then triggers initiating the clusters at the RDC 502 using the automation platform module 501, as illustrated in block 706.

In block 708, the clusters are configured and this process will not be described.

The automation platform module 501 is started by a system administrator or by any other user interested in setting up a cluster. The automation platform module 501 then invokes the cluster configuration software on the server, such as a virtual module server, running cluster configuration software.

### Stretching the Containerized Applications

In some embodiments, containerized applications (e.g., Kubernetes clusters) are used in 5G to stretch a private cloud network to/from a public cloud network. Each of the workload clusters in a private network is controlled by master nodes and support functions (e.g. MTCIL) that are run in the public cloud network.

Also, a virtualization platform runs the core and software across multiple geographic availability zones. A data center within the public network 8002/cloud stretches across multiple availability zones (“AZs”) in a public network to host: (1) stack management and automation solutions (e.g. the automation platform module, the virtual module, etc.) and (2) cluster management module and the control plane for the RAN clusters. If one of the availability zones fails, another of the availability zones takes over, thereby reducing outages. More details are presented below of this concept.

A private network (sometimes referred to as a data center) resides on a company's own infrastructure, and is typically firewall protected and physically secured. An organization may create a private network by creating an on-premises infrastructure, which can include servers, towers, RRUs, and various software, such as DUs. Private networks are supported, managed, and eventually upgraded or replaced by the organization. Since private clouds are typically owned by the organization, there is no sharing of infrastructure, no multi-tenancy issues, and zero latency for local applications and users. To connect to the private network, a user's device must be authenticated, such as by using a pre-authentication key, authentication software, authentication handshaking, and the like.

Public networks alleviate the responsibility for management of the infrastructure since they are by definition hosted by a public network provider such as AWS, Azure, or Google Cloud. In and infrastructure-as-a-service (IaaS) public network deployment, enterprise data and application code reside on the public network provider servers. Although the physical security of hyperscale public network providers such as AWS is unmatched, there is a shared responsibility model that requires organizations that subscribe to those public network services to ensure their applications and network are secure, for example by monitoring packets for malware or providing encryption of data at rest and in motion.

Public networks are shared, on-demand infrastructure and resources delivered by a third-party provider. In a public network deployment the organization utilizes one or more types of cloud services such as software-as-a-service (SaaS), platform-as-a-service (PaaS) or IaaS from public providers such as AWS or Azure, without relying to any degree on private cloud (on-premises) infrastructure.

A private network is a dedicated, on-demand infrastructure and resources that are owned by the user organization. Users may access private network resources over a private network or VPN; external users may access the organization's IT resources via a web interface over the public network. Operating a large datacenter as a private network can deliver many benefits of a public network, especially for large organizations.

In its simplest form, a private network is a service that is completely controlled by a single organization and not shared with other organizations, while a public network is a subscription service that is also offered to any and all customers who want similar services.

Regardless, because cellular networks are private networks run by a cellular provider, and the control of the containerized applications (e.g., Kubernetes clusters) and the control plane needs to be on a public network which has more processing power and space, the containerized applications (e.g., Kubernetes clusters) need to originate on the public network and extend or “stretch” to the private network.

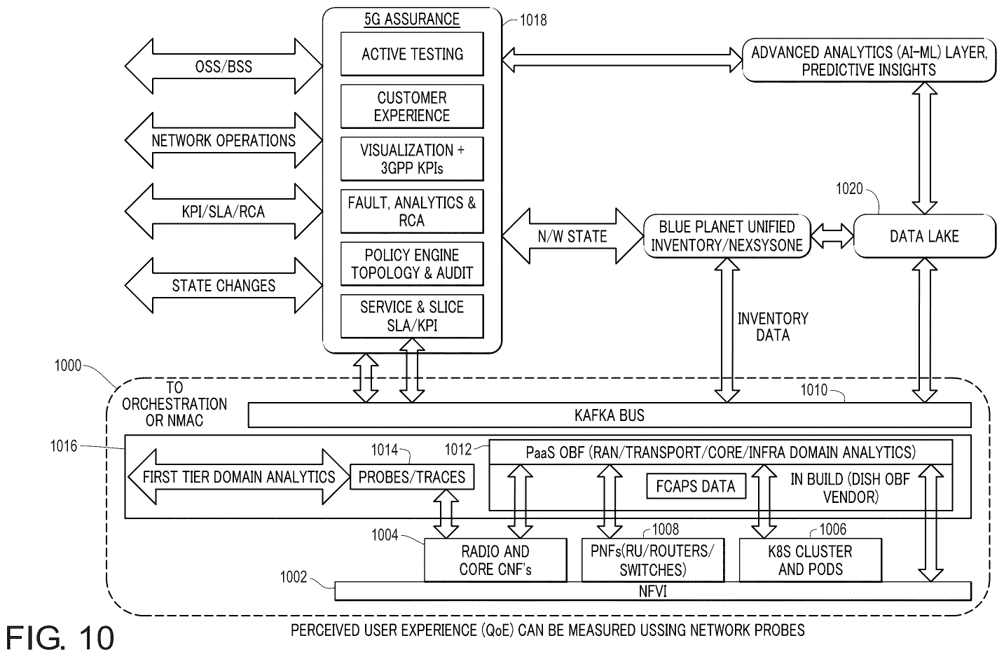

FIG. 10 illustrates a block diagram of stretching the containerized applications (e.g., Kubernetes clusters) from a public network to a private network and across the availability zones, according to various embodiments.

This is done by the automation platform module 501 creating master modules 512 in the control plane 800 located within the public network 802. The containerized applications (e.g., Kubernetes clusters) are then created as explained above but are created in both private networks 804 and public networks 802.

The public network 802 shown in FIG. 10 shows that there are three availability zones AZ1, AZ2 and AZ3. These three availability zones AZ1, AZ2 and AZ3 are in three different geographical areas. For example, AZ1 may be in the western area of the US, AZ2 may be in the Midwestern area of the US, and AZ3 may be in the east coast area of the US.

A national data center (NDC) 806 is shown as deployed over all three availability zones AZ1, AZ2 and AZ3 and the workloads will be distributed over these three availability zones AZ1, AZ2 and AZ3. It is noted that the NDC 806 is a logical creation of the data center instead of a physical creation over these zones. The NDC 806 is similar to the RDC 502 but instead of being regional, it is stretched nationally across all availability zones.

It is noted that the control plane 800 stretches across availability zones AZ1 and AZ2 but could be stretched over all three availability zones AZ1, AZ2 and AZ3. If one of the zones fails, the control plane 800 would automatically be deployed on the other zone. For example, if zone AZ1 fails, the control plane 800 would automatically be deployed on AZ2. This is because each of the software programs which are deployed on one zone are also deployed in the other zone and are synced together so that when one zone fails, the duplicate started software automatically takes over. This creates significant stability.

Moreover, because the communication is to and from a private network, the communications between the public and private networks may be performed by pre-authorizing the modules on the public network to communicate with the private network.

The private network 804 includes the LDC 504 and cell sites 506 as well as an extended data center (EDC) 580. The LDC 504 and cell sites 506 interact with the EDC 580 as the EDC 580 acts a router for the private network 804. The EDC 580 is configured to have a concentration point where the private network 804 will extend from. All of the LDCs 504 and cell sites 506 connect to only the EDC 580 so that all of the communications to the private network 804 can be funneled through one point.

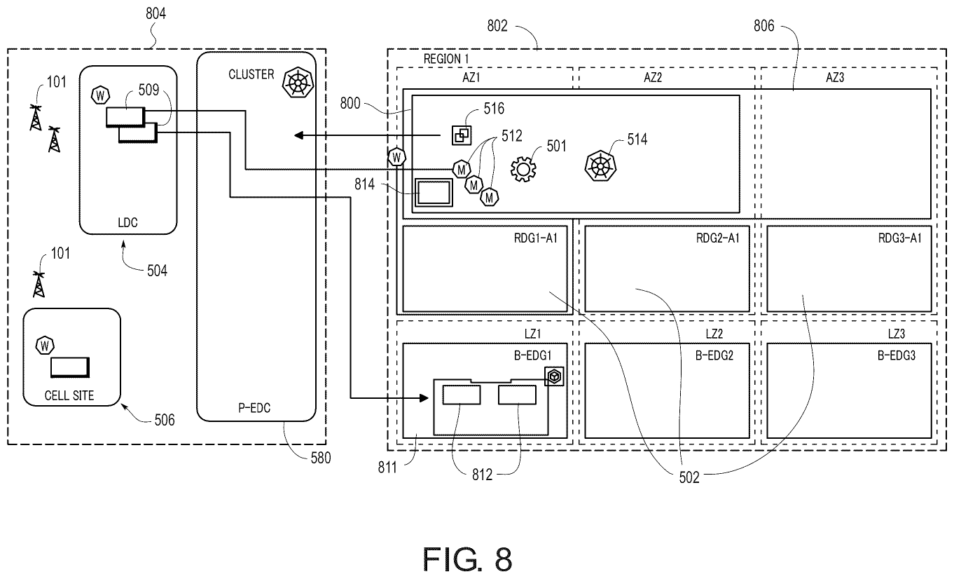

The master modules 512 control the DUs so that the clusters are properly allowing communications between the private network 804 and the public network 802. There are multiple master modules 512 so that if one master module fails, one of the other master modules takes over. For example, as shown in FIG. 8, there are three master modules 512 and all three are synced together so that if one fails, the other two are already synced together to automatically become the controlling master.

Each of the master modules 512 performs the functions of discussed above, including creating and managing the DUs 509. This control is shown over path B which extends from a master module 512 to each of the DUs 509. In this regard, the control and observability of the DUs 509 occurs only in the public network 802 and the DUs and the clusters are in a private network 804.

There is also a module for supporting functions and PaaS (the support module 814). There are some supporting functions that are required for observability and this support module 814 will provide such functions. The support module 814 manages all of the DUs from an observability standpoint to ensure it is running properly and if there are any issues with the DUs, notifications will be provided. The support module 814 is provided on the public network 802 to monitor any of the DUs 509 across any of the availability zones.

The master modules 512 thus create and manage the Kubernetes clusters and create the DUs 509 and the support module 814, and the support module 814 then supports the DUs 509. Once the DUs 509 are created, they run independently, but if a DU fails (as identified by the support module8) then the master module 512 can restart the DU 509.

Once the software (e.g., clusters, DUs 509, support module 814, master module 512, etc.) is set up and running, the user voice and data communications received at the towers 101 and is sent over the path of communication A so that the voice and data communications is transmitted from tower 101, to a DU 509, and then to the CU 812 in a EKS cluster 811. This path of communication A is separate from the path of communication B for management of the DUs for creation and stability purposes.

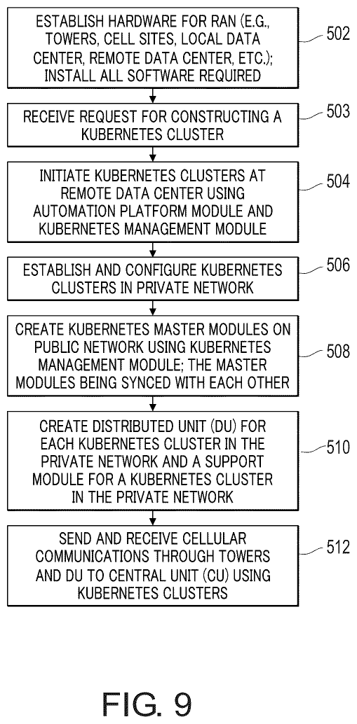

FIG. 9 illustrates a method of establishing cellular communications using containerized applications (e.g., Kubernetes clusters) stretched from a public network to a private network. Blocks 902, 903 and 904 of FIG. 9 are similar to Blocks 702, 704 and 706 of FIG. 7.

Block 906 of FIG. 9 is also similar to 708 of FIG. 7 except that the containerized applications (e.g., Kubernetes clusters) will be established on the private network from the public network. The containerized applications (e.g., Kubernetes clusters) can also be established on the public network as well. To establish the containerized applications on the private network, the private network allows a configuration module on the public network to access the private network servers and to install the workers on the operating systems of the servers.

In block 908, master modules are created on the public network as explained above. One of the master modules controls the workers on the private network. As discussed above, the master modules are all synced together.

In block 910, the DUs are created for each of the containerized applications (e.g., Kubernetes clusters) on the private network. This is accomplished by the active master module installing the DUs from the public network. The private network allows the active master module access to the private network for this purpose. Once the DUs are installed and configured to the RRUs and the corresponding towers, the DUs then can relay communications between the towers and the CU located on the public network.

Also in block 910, the support module is created on the public network and is created by the active master module. This support module provides the functions as established above and the private network allows access thereto for such support module to monitors each of the DUs on the private network.

Last, block 912 of FIG. 9 is similar to block 714 of FIG. 7. However, the communications proceed along path A in FIG. 8 as explained above and the management and monitoring of the DUs is performed along the Kubernetes clusters along path B.

### Observability

While the network is running, the support module will collect various data to ensure the network is running properly and efficiently. This observability framework (“OBF”) collects telemetry data from all network functions that will enable the use of artificial intelligence and machine learning to operate and optimize the cellular network. The observability framework described herein may also be configured to monitor the no load and low load characteristics in order to allow for the energy-saving characteristics and other features described earlier to occur. That is, the system 1000 described herein may include the processors configured assessing a characteristic of at least a portion of the cellular network described earlier, and also to reducing power to at least one part of the antenna or otherwise adjust some aspect of the cellular network.

This adds to the telecom infrastructure vendors that support the RAN and cloud-native technologies as a provider of Operational Support Systems (“OSS”) services. Together, these OSS vendors will aggregate service assurance, monitoring, customer experience and automation through a singular platform on the network.

The OBF brings visibility into the performance and operations of the network's cloud-native functions (“CNFs”) with near real-time results. This collected data will be used to optimize networks through its Closed Loop Automation module, which executes procedures to provide automatic scaling and healing while minimizing manual work and reducing errors.

This is shown in FIG. 10, which is described below.

FIG. 10 illustrates the network described above but also explains how data is collected according to various embodiments. The system 1000 includes the networked components 1002-1006 as well as the observability layers 1010-1014.

First, a network functions virtualization infrastructure (“NFVI”) 1002 encompasses all of the networking hardware and software needed to support and connect virtual network functions in carrier networks. This includes the cluster creation as discussed herein.

On top of the NFVI, there are various domains, including the Radio (or RAN) and Core CNFs 1004, clusters (e.g., Kubernetes clusters) and pods (or containers) 1006 and physical network functions (“PNFs”) 1008, such as the RU, routers, switches and other hardware components of the cellular network. These domains are not exhaustive and there may be other domains that could be included as well.

The domains transmit their data using probes/traces 1014 to a common source, namely a Platform as a Server (“PaaS”) OBF layer 1012. The PaaS OBF layer 1012 may be located within the support module on the public network so that it is connected to all of the DUs and CU to pull all of the data from the RANs and Core CNFs 1004. As such all of the data relating to the RANs and Core CNFs 1004 are retrieved by the same entity deploying and operating the each of the DUs of the RANs as well as the operator of the Core CNFs. In other words, the data and observability of these functions do not need to be requested from vendors of these items and instead are transmitted to the same source which is running these functions, such as the administrator of the cellular network.

The data retrieved are key performance indicators (“KPI”) and alarms/faults. KPI are the critical indicators of progress toward performing cellular communications and operations of the cellular network. KPIs provides a focus for strategic and operational improvement, create an analytical basis for decision making and help focus attention on what matters most. Performing observability with the use of KPIs includes setting targets (the desired level of performance) and tracking progress against that target.

The PaaS OBF and data bus (e.g., Kafka bus) retrieves the distributed data collection system so that such data can be monitored. This system uses the containerized application (e.g., Kubernetes cluster) structure, uses a data bus such as Kafka as an intermediate node of data convergence, and finally uses data storage for storing the collected and analyzed data.

In this system, the actual data collection tasks may be divided into two different functions. First the PaaS OBF is responsible for collecting data from each data domain and transmitting it to data bus and then, the data bus is responsible for persistent storage of data collected from data consumption after aggregation. The master is responsible for maintaining the deployment of the PaaS OBF and data bus and monitoring the execution of these collection tasks.

It should be noted that a data bus may be any data bus but in some embodiments, the data bus is a Kafka bus but the present invention should not be so limited. Kafka may be used herein simply as illustrative examples. Kafka is currently an open source streaming platform that allows one to build a scalable, distributed infrastructure that integrates legacy and modern applications in a flexible, decoupled way.

The PaaS OBF performs the actual collection task after registering with the master module. Among the tasks, the PaaS OBF aggregates the collected data into the Kafka bus according to the configuration information of the task, and stores the data in specified areas of the Kafka bus according to the configuration information of the task and the type of data being collected.

Specifically, when PaaS OBF collects data, it needs to segment data by time (e.g., data is segmented in hours), and the time segment information where data is located is written as well as the collected data entity in the data bus. In addition, because the collected data is stored in the data bus in the original format, other processing systems can transparently consume the data in the data bus without making any changes.

In the process of executing the actual collection task, the PaaS OBF also needs to maintain the execution of the collection task, and regularly reports it to the specific data bus, waiting for the master to pull and cancel the consumption. By consuming the heartbeat data reported by the slave in Kafka (for example), the master can monitor the execution of the collection task of the PaaS OBF and the data bus.

As can be seen, all of the domains are centralized in a single layer PaaS OBF 1212. If some of the domains are provided by some vendors and other by other vendors and these vendors would typically collect data at their networks, the PaaS OBF collects all of the data over all vendors and all domains in a single layer PaaS OBF 1012 and stores the data in a centralized long term storage using the data bus. This data is all accessible to the system at a centralized database or centralized network, such as public network 802 discussed above with regard to FIG. 8. Because all of the data is stored in one common area from various different domains and even from products managed by different vendors, the data can then be utilized in a much more efficient and effective manner

After the data is collected across multiple domains, the data bus (e.g., Kafka) is used to make the data available for all domains. Any user or application can receive data to the data bus to retrieve data relevant to thereto. For example, a policy engine from a containerized application such as a Kubernetes cluster may not be getting data from the Kafka bus, but through some other processing, it indicates that may need to receive data from the Radio and Core CNF domain so it can start pulling data from the Kafka bus or data lake on its own.

It should be known that any streaming platform bus may be used and the Kafka bus is used for ease of illustration of the invention and the present invention should not be limited to such a Kafka bus.

Kafka is unique because it combines messaging, storage and processing of events all in one platform. It does this in a distributed architecture using a distributed commit log and topics divided into multiple partitions.

With this distributed architecture, the above-described data bus is different from existing integration and messaging solutions. Not only is it scalable and built for high throughput but different consumers can also read data independently of each other and in different speeds. Applications publish data as a stream of events while other applications pick up that stream and consume it when they want. Because all events are stored, applications can hook into this stream and consume as required—in batch, real time or near-real-time. This means that one can truly decouple systems and enable proper agile development. Furthermore, a new system can subscribe to the stream and catch up with historic data up until the present before existing systems are properly decommissioned. The uniqueness of having messaging, storage and processing in one distributed, scalable, fault-tolerant, high-volume, technology-independent streaming platform provides an advantage over not using the above-described data bus extending over all layers.

There are two types of storage areas shown in FIG. 10 for collection of the data. The PaaS OBF is the first data storage 1016. In this regard, the collection of data is short term storage by collecting data on a real time basis on the same cloud network where the core of the RAN is running and where the master modules are running (as opposed to collecting the data individually at the vendor sites). Here, the data is centralized for short term storage, as described above.

Then, the second data storage is shown as box 1018, which is longer term storage on the same cloud network as the first data storage 1016 and the core of the RAN. This second data storage allows data that can be used by any applications without having to request the data on a database or network in a cloud separate from the core and master modules.

There are other storage types as well such as a data lake 1020 which provides more of a permanent storage for data history purposes.

It should be noted that the data collected for all storage types are centralized to be stored on the public network, such as the public network 802 discussed above with regard to FIG. 8.

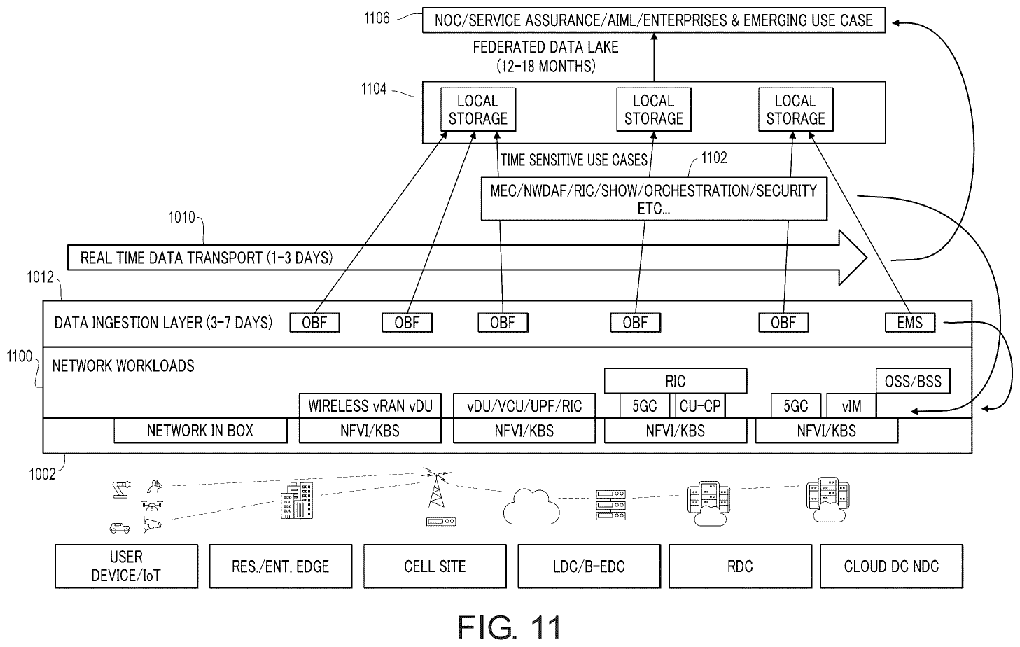

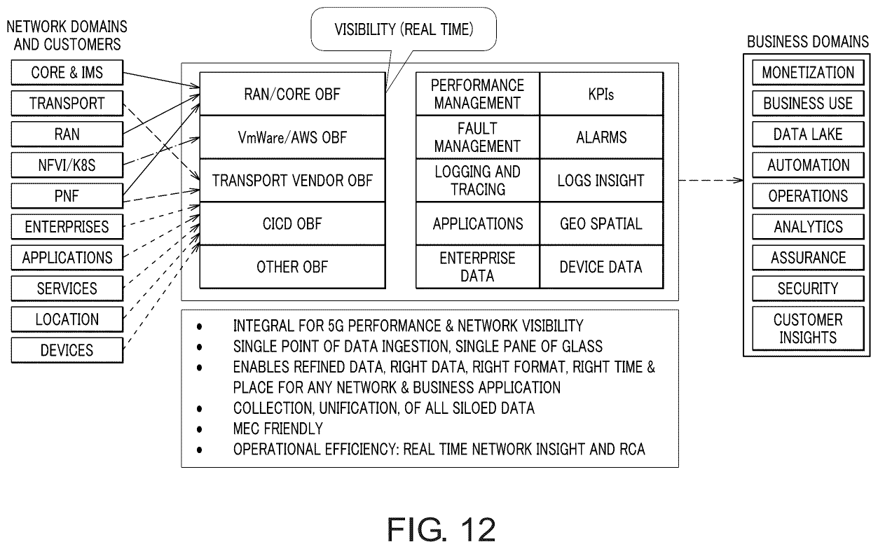

FIGS. 11 and 12 show an overall architecture of the OBF as well as the layers involved. First, in FIG. 11, there are three layers shown: the PaaS OBF layer 1012, the data bus layer 1010 and the storage layer 1104. There are time sensitive use applications 1102 which use the data directly from the data bus for various monitoring and other applications which need data on a more real-time basis, such as MEC, security, orchestration, etc. Various applications may pull data from the PaaS OBF layer since this is a real-time data gathering.

There are other use cases 1106 that can obtain data either from the PaaS OBF layer 1012, the data bus layer 1010 and the storage layer 1104, depending on the applications. Some applications may be NOC, service reassurance, AIML, enterprises, emerging use, etc.

As shown in FIG. 11, there are more details on various domains 1100, such as cell sites (vDU, vRAN, etc.), running on the NFVI 1002 layer. Also, as shown, the NFVI receives data from various hardware devices/sites, such as from cell sites, user devices, RDC, etc.

In FIG. 12, the network domains and potential customers/users are shown on the left with core and IMS, transport, RAN, NFC/Kubernetes (K8S), PNF, enterprises, applications, services, location, and devices. All of these domains are collected in one centralized location using various OBF collection means. For example, data from the core and IMS, RAN, and NFC/Kubernetes domains are collected using the RAN/Core OBF platform of the PaaS layer 1012. Also, data from the RAN and PNF domains are collected on the transport OBF layer. In any event, all of the data from the various domains and systems, whether or not there are multiple entities/vendors managing the domains, are collected at a single point or single database and on a common network/server location. This allows the applications (called “business domains” in the right hand side of FIG. 14) to have a single point of contact to retrieve whatever data is needed for those applications, such as security, automation, analytics, assurance, etc.

Although specific embodiments were described herein, the scope of the invention is not limited to those specific embodiments. The scope of the invention is defined by the following claims and any equivalents therein.

As will be appreciated by one skilled in the art, aspects of the present disclosure may be embodied as a system, a method or a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer readable storage medium would include the following: a portable computer diskette, a hard disk, a radio access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a non-transitory computer readable storage medium may be any tangible medium that can contain, or store a program for use by or in connection with an instruction execution system, apparatus, or device.

Aspects of the present disclosure are described above with reference to flowchart illustrations and block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figs. illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for allocating capacity of a radio unit to an antenna of a cell site, comprising:
identifying a plurality of antenna ports of the radio unit;
obtaining a capacity for each of the plurality of antenna ports;
assessing a throughput of a first antenna in the plurality of antennas;
determining, based on the throughput and the capacities, a configuration for the first antenna;
dynamically selecting, based on the capacities and the configuration for the first antenna, one or more antenna ports in the plurality of antenna ports to allocate to the first antenna; and
allocating the one or more antenna ports of the radio unit to the first antenna.

2. The method of claim 1, wherein obtaining the capacity for each of the plurality of antenna ports comprises:
obtaining a maximum bandwidth for each of the plurality of antenna ports.

3. The method of claim 1, wherein allocating the one or more antenna ports of the radio unit to the first antenna comprises:
reducing a number of antenna ports of the radio unit that are allocated to the first antenna.

4. The method of claim 1, further comprising:
selecting a second antenna in the plurality of antennas;
assessing a throughput of the second antenna;
dynamically selecting, based on the throughput of the second antenna, an antenna port of the plurality of antenna ports to allocate to the second antenna; and
allocating the selected antenna port to the second antenna of the plurality of antennas.

5. The method of claim 1, further comprising:
selecting an antenna port of the plurality of antenna ports that is allocated to a second antenna of the plurality of antennas; and
turning off the selected antenna port.

6. The method of claim 5, further comprising:
after the selected radio unit port is turned off:
determining that the throughput of the first antenna exceeds a throughput threshold; and
in response to determining that the throughput of the first antenna exceeds the throughput threshold, turning on the selected radio unit port for the second antenna.

7. The method of claim 5, wherein selecting the antenna port of the plurality of antenna ports that is allocated to the second antenna of the plurality of antennas comprises:
selecting an antenna port of the plurality of antenna ports that is allocated to the second antenna of the plurality, wherein a sector of the first antenna overlaps with a sector of the second antenna.

8. The method of claim 1, wherein assessing the throughput of the first antenna comprises:
assessing a current bandwidth of the first antenna.

9. The method of claim 1, further comprising:
selecting an antenna port in the plurality of antenna ports that is allocated to a second antenna; and
turning off an antenna amplifier that is in communication with the selected antenna port.

10. The method of claim 1, wherein dynamically selecting the one or more radio unit ports comprises:
determining that a transmitting throughput of the first antenna is less than a combined capacity of two transmitting antenna ports in the plurality of antenna ports; and
determining that a receiving throughput of the first antenna is greater than a combined capacity of two receiving ports in the plurality of antenna ports; and
selecting, as the one or more antenna ports, two transmitting antenna ports and four receiving antenna ports in the plurality of antenna ports.

11. The method of claim 1, wherein assessing the throughput of the first antenna comprises:
assessing an anticipated throughput of the first antenna.

12. The method of claim 1, wherein assessing the throughput of the first antenna comprises:
assessing a receiving throughput of the first antenna.

13. The method of claim 1, further comprising:
connecting the one or more antenna ports to one or more antenna power amplifiers that are connected to the first antenna.

14. The method of claim 1, wherein the first antenna is in communication with at least two radio units.

15. A system for allocating antenna ports of a radio unit between a plurality of antennas of a cell site, the system comprising:
the plurality of antennas of the cell site of a cellular network;
a central unit (CU);
a distributed unit (DU) in communication with the central unit;
the radio unit (RU) in communication with one or more antennas of the plurality of antennas, and that is controlled using the distributed unit; and
a processor configured to execute computer instructions to:
assess a bandwidth utilization of a first antenna in the plurality of antennas;
determine, based on the bandwidth utilization of the first antenna, a configuration for the first antenna;
dynamically select, based on the configuration for the first antenna, a first set of antenna ports of the radio unit to allocate to the first antenna; and
allocate the first set of antenna ports of the radio unit ports to the first antenna.

16. The system of claim 15, wherein the processor is further configured to:
select an inactive antenna port in the plurality of antenna ports, wherein the inactive antenna port is allocated to a second antenna of the plurality of antennas; and
cause an antenna amplifier in communication with the inactive antenna port to enter a reduced-power state.

17. The system of claim 15, wherein the processor dynamically selects the first set of antenna ports of the radio unit by being further configured to:
determine that a transmitting throughput of the first antenna is less than a maximum combined transmitting bandwidth of the first set of antenna ports of the radio unit.

18. A cellular network comprising:
radio access network nodes, wherein each radio access node includes:
a central unit;
a distributed unit;
one or more radio units controlled by the distributed unit; and
a plurality of antennas, wherein each antenna in the plurality of antennas is connected to at least one radio unit in the one or more radio units; and
one or more processors configured to collectively execute computer instructions to:
identify a first sector and a second sector of a cell site;
assess a first throughput of a first antenna of a plurality of antennas associated with the first sector;
assess a second throughput of a second antenna of the plurality of antennas associated with the second sector;
dynamically select, based on the first throughput and the second throughput, a first set of antenna ports from the plurality of antenna ports to allocate to the first antenna and a second set of antenna ports from the plurality of antenna ports to allocate to the second antenna;
allocate the first set of antenna ports to the first antenna; and
allocate the second set of antenna ports to the second antenna.

19. The cellular network of claim 18, wherein the one or more processors identify the first sector and the second sector by being further configured to:
identify the first sector and the second sector such that the first sector and the second sector at least partially overlap.

20. The cellular network of claim 18, wherein the one or more processors are further configured to:
select an antenna port of the radio unit that is allocated to the first antenna; and
allocate the antenna port of the radio unit to the second antenna.
